(19) United States
(12) Patent Application Publication
(10) Pub. No.: US 2009/0212262 A1
(43) Pub. Date: Aug. 27, 2009

(54) ELECTRODE FOR USE IN A DEIONIZATION APPARATUS AND METHOD OF MAKING THE SAME

(75) Inventors: Brian Elson, Pueblo, CO (US); Peter Norman, Pueblo West, CO (US); James R. Fajt, Station, TX (US)

Correspondence Address: DARBY & DARBY P.C., P.O. BOX 770, Church Street Station, New York, NY, 10008-0770, US

(73) Assignee: THE WATER COMPANY LLC, Pueblo (US)

(21) Appl. No.: 11/574,524

(22) PCT Filed: Sep. 2, 2005
(86) PCT No.: PCT/US05/31362

§ 371 Date: Sep. 30, 2008

Related U.S. Application Data
(60) Provisional application No. 60/607,028, filed on Sep. 3, 2004.

(51) Int. Cl. H01B 1/20; C04B 35/64

(52) U.S. Cl. 252/500; 264/618

(57) ABSTRACT

An electrode for use in a deionization apparatus is provided and is formed of (1) at least one polymerization monomer selected from the group consisting of phenol, furfural alcohol, dihydroxy benzenes; trihydroxy benzenes; dihydroxy naphthalenes and trihydroxy naphthalenes and mixtures thereof; (2) a crosslinker; and (3) a catalyst; or reaction products thereof, together in a carbonized form that is free of a carbon fiber reinforcing agent.

### TECHNICAL FIELD

The present invention relates generally to an electrochemical separation electrode for removing ions, holding, oxidizing and reducing contaminants and impurities from water, fluids and other aqueous process streams and for placing the removed ions back into a solution during a regeneration operation. The invention further relates to a method of making the same.

### BACKGROUND

There are a number of different systems for the separation of ions and impurities from water effluents or the like. For example, conventional processes include but are not limited to ion exchange, reverse osmosis, electrodialysis, electrodeposition and filtering. Over the years, a number of apparatuses have been proposed for performing deionization and subsequent regeneration of water effluents, etc.

One proposed apparatus for the deionization and purification of water effluents is disclosed in U.S. Pat. No. 6,309,532. The separation apparatus uses a process that can be referred to as a capacitive deionization (CDI) and in contrast to other conventional ion exchange processes, this process does not require chemicals, whether acids, bases or salt solutions for the regeneration of the system; but rather, this system uses electricity. A stream of electrolyte to be processed, containing various anions and cations, electric dipoles, and/or suspended particles, is passed through a stack of electrochemical capacitive deionization cells during a deionization (purification) cycle. Such electrode in the cells attracts particles or ions of the opposite charge, thereby removing them from solution.

Thus, the system is configured to perform deionization and purification of water influents and effluents. For example, one type of system includes a tank having a plurality of deionization cells that is formed of non-sacrificial electrodes of two different types. One type of electrode is formed from a carbon based inert carbon matrix (ICM). This electrode removes and retains ions from an aqueous solution when an electrical current is applied. The other type of electrode, formed from a conductive material, does not remove or removes fewer ions when an electric current is applied and therefore is classified as being non-absorptive (“non-ICM electrode”). This property is common to electrodes formed from carbon cloth, graphite, titanium, platinum and other conductive materials that do not degrade in the electric field in an aqueous solutions. The non-ICM carbon electrode is formed as a dual electrode in that it has a pair of conductive surfaces that are electrically isolated from one another.

Accordingly, in one embodiment, the apparatus includes a number of conductive, non-sacrificial electrodes each in the form of a flat plate, that together in opposite charge pairs form a deionization cell. During operation, a voltage potential is established between a pair of adjacent electrodes. This is accomplished by connecting one lead of a voltage source to one of the electrodes and another lead is attached to the electrodes that are adjacent to the one electrode so as to produce a voltage potential therebetween.

In order to construct a stable, robust ICM electrode, a reinforcer is used to strengthen the high surface area absorptive material. Typically, the reinforcer is in the form of a carbon source, such as carbon felt, granular carbon or carbon fiber; however, it can also be in the form of a carbon/cellulose or carbon silica mixture. The carbon source is used as reinforcement in the formation of the electrode and while it can come in different forms, it is important that the carbon reinforcement be electrically conductive and not reduce the electrical conductance of the electrode. A carbon source is selected to permit the electrode to have the necessary conductive properties and must also be fully dispersed in the other materials that form the ICM electrode, namely a resorcinol-formaldehyde liquor, which then sets, or can absorb a similar quantity of the liquor in a matrix and then set.

The non-homogeneity of the prior art electrodes that contain fiber reinforcement affects its absorptive and electrical properties. More specifically, the use of carbon fibers as a carbon reinforcement provides fewer attachment sites for ions and the electrode also tends to be less balanced in the removal of positive and negative ions. Thus, it is desirable to produce a homogenous electrode that is robust and has increased reinforcement characteristics without the use of conventional fiber reinforcement.

### SUMMARY

According to one aspect, the present invention is generally directed to a system or apparatus for the deionization and purification of influents or effluents, such as process water and waste water effluents: and more particularly, is directed to a non-sacrificial electrode as well as a method of making the same. The electrodes of the invention, which employ a particulate reinforcement (which is preferably a particulate reinforcement material that is the same chemical composition as the electrode itself) does not require a carbon-fiber based reinforcement.

The electrode used in the present deionization apparatus is generally produced by first introducing a granular conductive carbon material to a liquor which is formed of a solvent and a polymerizing agent. The reinforcing material is solidified and carbonized and then is preferably machined into the electrode.

According to one exemplary embodiment, the process for making the electrode includes the steps of (1) making a first liquor including at least one polymerization monomer dissolved in a first crosslinker (crosslinking agent), (2) wetting a granular conductive carbon material with a solvent and first liquor mixture, (3) adding a second crosslinker to the first liquor, solvent, conductive carbon material mixture, (4) maintaining the fixture for a sufficient time and at a sufficient temperature until the mixture polymerizes into a solid and (5) carbonizing the solid for a sufficient time and at a sufficient temperature such that the solid carbonizes into an electrically conductive substrate.

The granular conductive material can be commercially purchased or it can be formed by (1) dissolving at least one material selected form the group consisting of dihydroxy benzenes, dihydroxy mapthalenes, trihydroxy benzenes and trihydroxy mapthalenes and mixtures thereof, in a second crosslinker to form a second liquor, (2) maintaining the second liquor for a sufficient time and at a sufficient temperature until the second liquor polymerizes into a solid (blank), (3) firing the blank at a sufficient temperature and for a sufficient time such that the blank carbonizes into an electrically conductive member and (4) processing the blank, after the blank cools, so as to break up the carbonized blank into the granular conductive carbon material.

One specific exemplary process for forming the present granular conductive carbon material reinforced electrode includes the steps of (1) dissolving at lease one material from the group consisting of dihydroxy benzenes, dihydroxy napthalenes, trihydroxybenzenes and trihydroxy napthalenes and mixtures thereof, with a crosslinker (e.g., formaldehyde (37% formalin solution)) to form a liquor (pre-react), (2) mixing the resultant liquor pre-react with a second crosslinker (37% formalin solution) for a sufficient time and at a sufficient temperature until the liquor polymerizes into a first solid (block), (3) firing the first block at a sufficient temperature and for a sufficient time such that the first block carbonizes into an electrically conductive member, (4) processing the first block, after the first block cools, so as to break up the carbonized first block into a uniform granular conductive carbon material, (5) dissolving at least one material form the group consisting of dihydroxy benzenes, dihydroxy napthalenes, trihydroxy benzenes and trihydroxy napthalenes and mixtures thereof, with a crosslinker (e.g., formaldehyde (37% formalin solution)) to form a second liquor(second pre-react), (6) wetting the processed granular conductive carbon material with a solvent, second liquor(second pre-react), (7) adding a final crosslinker (37% formalin solution) to the second liquor, solvent, and processed granular carbon material mixture and mixing for a sufficient time and at a sufficient temperature until the mixture polymerizes into a second solid (block), and (8) firing the second block for a sufficient time and at a sufficient temperature such that the second block carbonizes into an electrically conductive structure that is a uniform homogeneous carbon material.

There are a number of advantages to having a more homogenous electrode as is realized in the present invention. For example, production of a homogenous electrode is important to optimizing operation of the device, ion removal, strength, porosity, flow characteristics, head loss and physical integrity of the electrode. In contrast, the present invention has more ion capacity compared to the prior art electrodes that contain carbon reinforcement. While the conventional process used carbon fiber as a filler material, the new process disclosed herein does not use a filler material and therefore has less raw ingredients. Moreover, the use of carbon fiber as a filler material in prior art electrodes reduces the amount of electrode area (surface area) that is functionally active during the separation process. In other words, the carbon fiber filler material merely acts as dead space within the electrode. In addition, one of the disadvantages to using fiber reinforcement is that it does not contain the structures to absorb ions from solution so its addition would reduce the active sites for removal of ions. The present electrode overcomes these disadvantages and deficiencies.

There are a number of advantages that are realized in having a more homogeneous electrode. In particular, the resistivity and electrical distribution throughout the electrode are more uniform when the electrode (plate) is homogenous. In addition, the present electrode overcomes a number of deficiencies of the prior art electrodes and they do solve a problem in that they make it possible to produce a thick self supportive electrode that is all made of the same carbon material. The present electrodes also produce a more equal or balances removal rate for both positive and negative ions. Moreover, the electrode manufacture according to the present method provides a uniform and continuous material that is capable of removing charged material (ions) from water. Since the electrode does not contain inert filler or reinforcer, all of the material in the electrode possesses this characteristic. The process also reduces the chance that the manufacturing process will result in an excessive exothermic reaction. Since the polymerization reaction is split into two parts, namely, a pre-reaction and final reaction, the amount of heat generated at each step is limited. This also reduces the risk to those performing the reaction and also reducing the complexity of the equipment used for manufacture of these electrodes.

Other features and advantages of the present invention will be apparent from the following detailed description when read in conjunction with the following drawings.

### BRIEF DESCRIPTION OF THE DRAWING FIGURES

The foregoing and other features of the present invention will be more readily apparent from the following detailed description and drawings of illustrative embodiments of the invention in which:

FIG. 1 is a perspective view of an electrochemical separation electrode according to a first embodiment

FIG. 2 is schematic illustrating a blank or electrode material being inserted into a heating device that is formed of two refractories;

FIG. 3 is a perspective view of an electrode with an electrical connection to a conductor according to a first embodiment;

FIG. 4 is a cross-sectional view taken along the line 4-4 of FIG. 3;

FIG. 5 is a perspective view of an electrode with an electrical connection to a conductor according to a second embodiment;

FIG. 6 is a cross-sectional view taken along the line 6-6 of FIG. 5;

FIG. 7 is a perspective view of an electrode with an electrical connection to a conductor according to a third embodiment;

FIG. 8 is a cross-sectional view taken along the line 8-8 of FIG. 7; and

FIG. 9 is a graph showing the results of X-ray diffraction (XRD) analysis performed on electrode materials made in accordance with the present invention compared to conventional electrode materials.

### DETAILED DESCRIPTION

As noted above, the present invention is directed to an electrode and water deionization devices employing this electrode. The electrode of the invention has superior strength, conductance, and absorption characteristics compared to prior electrodes for water deionization. Perhaps as importantly, the manufacturing process is simple and in certain embodiments employs readily available starting materials. Thus, the invention greatly facilitates development of cost-effective water deionization devices for industrial, commercial, and residential decontamination uses.

Non-Sacrificial Electrode

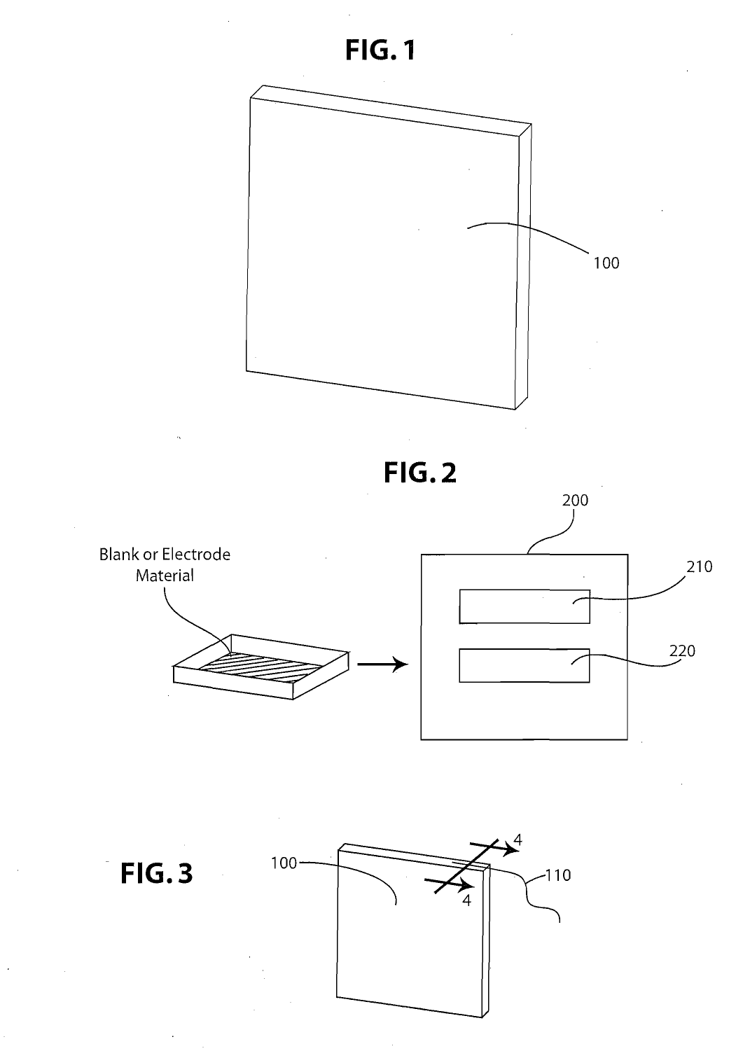

The present invention generally refers to an electrochemical separation electrode 100 (FIG. 1) for removing charged particles, ions, contaminants and impurities from water, fluids and other aqueous or polar liquid process streams and its suitable applications. For example and according to one exemplary embodiment, the present electrode 100 is particularly suited for use in a deionization apparatus that includes a number of parallel arranged, upstanding electrodes 100. As discussed below, the apparatus can include a single type of electrode or the apparatus can be formed of more than one type of electrode arranged in an alternating pattern within the apparatus. For example and according to one deionization scheme, a single type electrode is used and arranged so that adjacent electrodes are oppositely charged for attracting particles of opposite charge. It will be understood and appreciated that apparatus merely illustrates one use of the present electrode and there are a great number of other uses for the electrode, including other deionization applications as well as other types of applications.

The electrode 100 can be used in a flow-through, flow by, or batch system configuration so that the fluid can utilize a charged surface area for attracting oppositely charged ions, particle, etc. A frame 30 can be disposed around the electrode 20 to provide structural support around the perimeter of the electrode 20.

The apparatus can be constructed in a number of different manners and the electrodes can be arranged in any number of different patterns within the apparatus. For example, U.S. Pat. Nos. 5,925,230; 5,977,015; 6,045,685; 6,090,259; and 6,096,179, which are hereby incorporated by reference in their entirety, disclose suitable constructions for the apparatus 10 as well as suitable arrangements for the electrodes contained therein. As stated above, in one embodiment, the apparatus includes a number of conductive, non-sacrificial electrodes that each is in the form of a flat plate-like member that together form a deionization cell. During operation, a voltage potential is established between a set of adjacent electrodes. This is accomplished by connecting one lead of a voltage source to one of the electrodes and another lead is attached to the electrodes that are adjacent to the one electrode so as to produce a voltage potential therebetween. This can result in adjacent electrodes being charged oppositely. However, it is to be understood that the above-described plate embodiment is merely exemplary in nature and not limiting of the present invention since the present invention can be manufactured to have a number of designs besides a plate configuration.

The electrode 100 of the present invention is generally formed in a series of steps that includes introducing a granular conductive carbon material into a polymer liquor (formed of a polymerization monomer and a crosslinker) to cast a blank, carbonizing the blank, and then, usually machining the carbonized blank to form the electrode. As described below in detail, the granular conductive material can be either prepared following a number of processing steps using materials that correspond to the electrode manufacturing process or can be obtained commercially. Preferably, the granular conductive material is pre-wetted and de-aired before the polymer solid is formed.

In the instance where the granular conductive carbon material is prepared as part of the electrode manufacturing process, a polymerized blank, which can be free of granular reinforcing material is first made, then carbonized and processed to form the granular conductive carbon material used in the final electrode. The present electrode is formed so that it does not require the use of a fiber reinforcer, which is typically in the form of a carbon source such as carbon felt, paper, or fiber or a carbon/cellulose mixture.

The electrode blank and the blank for preparing the granular material are generally formed from the polymer liquor, which is formed of a number of ingredients including the polymerization monomer, the crosslinker, an optional catalyst or activator, and inert ingredients, such as water, alcohol, etc., as described below in greater detail.

Polymer Liquor

Accordingly, the polymer liquor refers to a mixture that includes a polymerization monomer as well as a crosslinker that is capable of dissolving the polymerization monomer as to suspend the polymerization monomer in solution. The polymer liquor can also contain inert ingredients, such as water, alcohols, etc. It can accommodate addition of a polymerization catalyst or activator that induces or accelerates the polymerization process.

Polymerization Monomer

The polymerization monomer should be (i) capable of crosslinking with other monomers to form a polymer which in turn (ii) can be carbonized to form an electrically conductive material. In one embodiment, preferred polymerizing agents are in the form of poly-hydroxy aryl groups, especially, di and tri hydroxyl benzene and naphthalene. A specific dihydroxy benzene for use in the invention is resorcinol. In a specific embodiment, the monomer is selected from the group consisting of phenol, furfural alcohol, dihydroxy benzenes, dihydroxy napthalenes, trihydroxy benzenes and trihydroxy napthalenes and mixtures thereof.

Resorcinol comes in many different grades and can be obtained from a number of suppliers in pellets, flakes, and other convenient forms. For example, resorcinol in a form suitable for organic chemical formulations, commercially available from the Hoechst Celanese Company, can be used to make the present electrode.

As mentioned, one preferred material is resorcinol catalyzed with a base. The resultant polymer must be capable of being carbonized and result in a highly-conductive material. Thus, if the material is to hold a shape, it must form a char as opposed to forming a liquid phase during any part of the carbonization. As a result, it is believed that the ring structure available in certain natural materials, such as coconut shells, possesses the basic structures in their cellulose structures, which can form a conductive carbon, which may be used.

Crosslinker

The solvent of the polymer liquor is typically in the form of a bi-reactive molecule or cross-linking agent that can dissolve the polymerizing agent to form the polymer liquor. One particularly preferred solvent is formalin. However, other crosslinkers can be used including gluteraldehyde or a solid source of formaldehyde, such as paraformaldehyde and Methenamine and hexamethylene tetramine. Formaldehyde is available from a variety of suppliers, and also comes in different grades and forms. For example and according to one embodiment, the formaldehyde can be in the form of formalin, which is suitable for dyes, resins and biological preservation, from the Georgia-Pacific Resin, Spectrum Chemical Company.

Catalyst

The catalyst regulates the polymerization rate. By varying the type of catalyst, the porosity and strength of the final product can be altered. Any number of catalysts can be used so long as they serve to initiate or accelerate crosslinking. For example, for resorcinol-formaldehyde type polymers, a caustic or base catalyst can be used and in particular, sodium carbonate, sodium hydroxide or potassium hydroxide or other base catalysts are suitable for use in the present invention. When methylol compounds are used, a base catalyst can initiate such a reaction. Also, it is desirable to use a catalyst that will introduce the least amount of contamination into the mixture.

Pre-Prepared Liquors

While preferred starting ingredients for the blank and electrode include mixed resorcinol/formaldehyde liquor, there are alternatives to mixing these reactants. Commercially available products and reacted mixtures of resorcinol and formaldehyde are available under the generic categories of resoles and novolaks. Each of these products is a mixture of resorcinol and formaldehyde and catalyst that is not reacted in molar ratios that will result in a solid. These alternatives permit a custom manufactured mixture to be provided that can be tailored to the desired molar and viscosity ratios of catalyst, formaldehyde, and resorcinol.

Granular Conductive Carbon Material

As described below in more detail and as used herein, the term “granular conductive carbon material” refers to a particulate matter that can be ground carbonized blank material or it can be another carbon-based particulate conductive material. Preferred granular conductive carbon materials are those which are materials that will neither sacrifice in an electrical field nor dissolve in water. At least in some applications, the granular conductive carbon can also be in the form of carbon nanotubes.

While in one embodiment, the granular conductive carbon material is formed by first creating the carbonized blank and then processing it so that it is broken into smaller particles, it will be understood that in another embodiment, the granular conductive carbon material can be commercially purchased and then used. The granular conductive carbon material adds structural strength and reinforcement and therefore, any material that strengthens and allows the material to remain conductive and perform ion removal is suitable for use in manufacturing the electrodes of the present invention. As a result, certain activated carbons and even glassy carbon structures can produce satisfactory results in certain applications.

Process for Forming the Electrode

The goal of making the electrode is to produce a flat, electrically conductive, homogenous, porous carbon structure that functions as an absorptive electrode in a deionization device that is constructed to remove ions from a liquid when an electric current is applied.

The manufacturing process for forming the electrode generally includes the steps of polymerizing a liquor (blank material), carbonizing that polymerized blank material into a granular conductive carbon material, polymerizing a second liquor with the granular conductive carbon material added to it and firing or carbonizing the second reinforced material to form an electrode. It can then be machined as desired.

Polymerizing the Blank

According to one exemplary manufacturing process, the polymerization monomer and crosslinker are measured out in appropriate amounts to form the polymer liquor that is used to form a pre-blank partial reaction and mixed. After the first polymerization reaction has finished the pre-blank polymer is mixed with additional crosslinker to form a blank with the desired physical characteristics. All mixtures are stirred until homogenous. A polymer initiator (catalyst) can be added to speed up the reaction however, it is possible for the polymerization process to proceed without the use of an initiator and in this case, polymerization occurs as a result of the passage of time. The polymer liquor is dispensed into a mold (e.g., an open top forming mold) that is preferably kept at a controlled temperature. The temperature of the mold can be maintained at a desired temperature using any number of conventional techniques, including the use of a heating element or the use of a bath or the like which is capable of maintaining the mold at the desired temperature. After letting the formed solid sit for a sufficient time period, the hardened solid is removed from the mold and carbonized.

The process of forming the blank reinforcement material thus begins with forming a polymer liquor with an approximately 0.4-0.6 to 1.0 molar ratio of the crosslinker to polymerization monomer. For example, a batch of 7500 grams of resorcinol solid is added to 2765 grams of formalin solution (37% formaldehyde with 11% methanol). After the first reaction has finished and cooled a final crosslinker volume is added to the mixture resulting in a molar ratio of approximately 1.2-1.8 to 1 crosslinker to polymerization monomer. For example, an additional 4975 grams of formalin solution (37% formaldehyde with 11% methanol) is added to the mixture in this specific example.

It will be understood that the above listed quantities are merely exemplary in nature and that these quantities can be scaled linearly, either upwards or downwards, to make different total quantities of the initial mixture that is used to form the blank.

The rate at which the polymerization monomer dissolves in the crosslinker depends on a number of factors, including the molar ratio between the two materials. Mixing or stirring the combination can aid the process and conversely, raising the temperature can result in the process being sped up. As is commonly known, when it comes to dissolving one material in another material, time can be traded for temperature and therefore, there are a number of different ranges of temperatures and times that can be used to dissolve the polymerization monomer in the crosslinker.

The polymer liquor is then permitted to polymerize by placing the polymer liquor in suitable conditions that allow the polymerization process to proceed. A catalyst can also be used to facilitate polymerization of the polymer. The polymerization time and catalyst and the temperature are controlled, with the temperature preferably being held between about 70° F. and 125° F. In view of the foregoing, the optimal way to make the blank is to control the temperature during polymerization to produce a solid uniform structure.

The Mold

The mold that is used to form the blank can have a number of different configurations and can be formed of a number of different materials. For example, the forming mold can be a stainless steel forming pan, such a 304 stainless, that is square shaped. However, it will be appreciated that the mold can be formed of other materials, such as aluminum and plastics that specifically don't have any bonding characteristics with the polymer liquid. One type of plastic that is suitable for making the mold is polyethylene; however, other plastics can be used to form the mold.

The mold is preferably prepared to receive the polymer liquor. More specifically, if the mold has a texture that will stick to the work piece, then a mold release agent is used to facilitate the removal of the solid that is subsequently formed in the mold. One exemplary mold release agent is carnauba wax that is spread on the surfaces of the mold prior to addition of the polymer liquor. It will be appreciated that there are other mold release agents that can be used with the mold. If a mold release agent is not used, then a liner can be directly incorporated into the metal mold. For example a polyethylene liner can be directly incorporated into a steel mold and this eliminates the need for the use of an applied release agent. However, it will be understood that the mold liner can also be made out of other materials, such a craft paper or any other material that will not bind with the polymer.

While the mold can be any shape or geometry that the polymer liquor can be poured, it also can be an injection mold. As is known, an injection mold includes two complementary portions that mate to form an enclosure. One or both of the complementary portions is provided with an inlet through which the polymer liquid is introduced and the injection mold is further provided with a vent. Injection can take place at a wide range of pressures, depending on the type of injection molding techniques used, the viscosity of the injectant, and other factors. In the alternative embodiment the mold is a container with a lid. However, it will be appreciated that the mold alternatively can be sealed cavity that is then regulated in terms of its temperature. For example, the mold can be immersed into a temperature-controlled bath that serves to control the temperature of the mold itself. However, the mold can have a solid state of flow-through temperature regulator that serves to control the temperature of the mold.

Curing the Blank

In one embodiment, the mold containing the polymer liquor mixture is introduced to convection type heating between about 70° F. to 145° F. for a time period of about 24 to 72 hours. Other heating sources may be used. During this curing stage the in-mold cured blocks are hard, and damp with some unreacted formaldehyde and are electrically non-conductive. One purpose of this in-mold heating is to accelerate the hardening and shrinkage so that the block can be removed form the mold.

The polymerized liquor is at this time amber, glassy appearing polymerized solid that is typically referred to as a xerogel. After the polymer liquor has set and turned to a solid and is removed or released form the mold.

Carbonization of the Blank

After the non-conductive blank un-reinforced polymer has been cured and it is removed form the mold the blank is placed in an oven so as to fire and carbonize it into the granular conductive carbon material. Preferably, the carbonization process is undertaken in an oven and is heated by any number of means, including but not limited to being heated by electricity, natural gas, ultraviolet or infrared energy, etc.

In one embodiment illustrated generally by FIG. 2, the heating device is an infrared heater, generally indicated at 200. The present applicants have discovered that the use of an infrared heater yields a number of desirable advantages, including a significant time savings in the preparation process. More specifically, carbonization process took generally from 1 to 4 hours in a conventional furnace, while, the carbonization process has been cut down to between about 10 minutes to about 30 minutes. This results in not only a significant time savings but also a cost savings since the production time is significantly reduced. In addition, the use of an infrared oven offers a number of other benefits/advantages, including the ability to have instant real-time control of the temperature. More particularly, conventional ovens have slow response times in that when a temperature change is needed and the oven is instructed to change temperature, there is typically a significant lag time before such new temperature is realized. In contrast, the use of the present infrared oven for carbonizing the present electrodes, as well as the granular reinforcement material, permits instant real-time control of the temperature within the oven and since the temperature can quickly be changed, if needed, and held at a specific temperature, the characteristics of the material can be controlled. By being able to precisely control the temperature heating profile of the oven in real-time, the electrical performance properties, e.g., conductivity, etc., of the electrode can be altered and tailored to a specific application.

Advantageously, the construction of the oven can lead to an improved manner of introducing heat to the blank that is placed in the oven for the purpose of carbonization thereof. In one embodiment, the oven includes two heated components 210, 220, which can be in the form of two infrared heater panels when the oven 200 is an infrared oven. In another embodiment, the oven includes a first refractory and a second refractory and according to one embodiment, the first refractory is a hearth refractory and the second refractory is a movable refractory. The movable refractory is disposed within the oven such that it represents the upper refractory of the two refractories; however, it will be appreciated that the lower refractory can be configured so that it is the movable refractory as opposed to the upper refractory. The refractory has a dual purpose but when it is used in the carbonization process with the blanks, the purpose of the refractory is to get the correct degree minutes per gram of heating so that the blank material is thoroughly raised to a predetermined temperature. For example, the blank material is heated to a temperature between about 700° C. to 1000° C.

Another parameter to observe is the atmosphere of the oven. In the present process, the atmosphere of the oven is not controlled with inert gas but rather, the atmosphere is controlled by the design of the oven. More specifically, the design of the oven is such that it prevents oxygen from being in contact with a major portion of the surface of the material of the blank due to the presence and construction of the upper and lower refractories. However, it will be appreciated that the atmosphere of the oven can be controlled using both inert gas and by design of the oven. In other words, an inert gas, such as nitrogen, can be used to control the atmosphere of the oven as opposed to using exhausted gases to accomplish this feature.

According to one embodiment, the material is in an oxygen-starved environment because the refractories prevent oxygen form penetrating. The oven is purged of atmosphere through the combustion gasses created in the initial first minutes of carbonization. After these initial minutes, there is no air brought into the oven and therefore, the material is in a reduced oxygen environment.

It will be appreciated that the purpose of firing the blank material is to convert it from a phenolic polymer or plastic into a carbon material. In other words, the firing process is a carbonization process. A suitable temperature range for the oven is between about 700° C. to about 1000° C. Temperatures that are not suitable are those temperatures at which the physical characteristics of the blank material become undesirable with respect to several aspects, including but not limited to, electrical conductivity; volume conductivity; and strength. The bulk resistivity of the carbonized material is high when the temperature is below 700° C. and if the temperature of the oven is too high the material will become too graphitic.

Subjecting the blank material to the above temperatures causes further desiccation and burns off many of the impurities present in the original ingredients. The blanks are then heated for a predetermined time period to complete the carbonization process and it has been determined that the time of heating and the temperature of heating together depend on the weight of the unheated blank. The heating protocol is significantly influenced by the thickness of the material.

A thermocouple can be used on the top of the material and is used to compare the material temperature to the oven temperature, with the temperature of the material lagging the oven temperature. Bulk resistivity is one of the primary checks to see if it has been converted into a usable carbon form. The carbonization of the blank material involves taking the plastic material and converting it to carbon.

After the blank material is completely fired and carbonized, the oven is opened and the carbonized blank material has an orange glow due to the temperature of the material. The blank material will be fractured and in pieces as a result of the carbonization process. The blanks can be fired in a container, such as a stainless steel pan, to prevent the loss of material. The pan retains the broken and fractured material so that recovery from the oven is complete. While the stainless steel may be suitable in some applications, stainless steel does not have to be the selected material of the container; however, the selected material should be able to withstand the high temperature and not add contamination to the blank conductive carbon material.

The container is removed mechanically with a tong or a pusher or some other type of tool that permits the container to be securely gripped and then removed form the hot oven. As the pan is removed form the oven, there is a slight hint of flame coming off of the blank material as it is exposed to oxygen. In order to prevent burning of the material after the container is removed from the oven, a refractory snuffing block can be provided and laid on the container to prevent oxygen form getting to the blank. It is also possible to create an environment where the material can cool quickly. Once the temperature of the blank reaches a predetermined temperature, such as 200° C., the carbonized blank can be removed from an oxygen reduced environment created by the snuffing block.

Formation of Granular Conductive Material

Once the blank is cooled to room temperature, the blank is then further processed. More specifically, the room-temperature blank is introduced to a process that is configured to break up the blank into smaller pieces. In one exemplary embodiment, the blank is run through a crushing hammer mill process that is constructed to break up the blank into particles that are of a known size and distribution. Any number of different methods can be used to break up the material into smaller particles. One preferred method for breaking up the blanks is to run the carbonized blank material through a jet mill. The jet mill requires a pre-crushing stage due to the fact that the jet mill cannot handle feed particles larger than ⅛ inch diameter. This pre-stage can be any means that will provide appropriately sized feed material for the jet mill. This material is extremely hard and abrasive so a tungsten carbide or equally hard material should be considered as the crushing material when using hammer mills or similar equipment.

Thus, it will be appreciated that any number of conventional milling processes and techniques can be used to form the granular conductive carbon material. The techniques disclosed herein are merely exemplary and not limiting of the present invention in any way.

According to one embodiment, the first step is to use the crusher to crush the big chunks and for example, the crusher reduces the big chunks of the blanks to a predetermined smaller size, e.g., about ⅛ inch in size prior to the subsequent step of using the jet mill device. This first device is therefore a preliminary tool or device (lump breaker or a crusher) that is used prior to the jet mill step. The ⅛ inch material is then taken form the lump breaker or crusher into the jet mill.

The hammer mill device is configured with the correct hammers, clearances and RPMs (all of which are variables) to produce the particle distribution size that is desired. Yet another function that can be controlled is the feed rate of the broken-up blank material into the hammer mill. It will be appreciated that there are other devices that can be used to grind or reduce the blank material to a smaller particle size. Thus, the use of the hammer mill is not critical to the present process and instead, a pin mill, a ball mill, a roller mill, etc., can be used.

After the broken-up blank material passes through the mill, the resulting particles of blank material size have a size that falls substantially within the range from about 20 micron to about 100 micron with a small percentage of the particles falling beyond this range. However, this range is merely one exemplary range and it will be appreciated that depending upon the application and upon the desired dimensions of the resulting crushed particles, the equipment (e.g., the crusher and the hammer mill) can be selected and arranged so as to produce particles of given, desired dimensions.

The purpose of forming a blank including the curing and then the carbonization thereof is to form a conductive carbon material and then the grinding thereof is to convert the large carbonized material into smaller micron sized conductive particles. This material can also be referred to as being a granular carbon material and can also be referred to as “black sand” due to its appearance in terms of it being a granular sand-like material (small particles) and its black color. This granular carbon material represents the starting material that is used to reinforce the electrode; however, it is different than the conventional carbon fiber fillers and results in the electrode having improved electrical performance characteristics.

Processing of the Granular Conductive Material to form an Electrode

The granular carbon material is typically a very porous, very dry material, particularly if it is prepared from a polymer blank as described above. Accordingly, prior to adding the polymer liquor, the granular material is first wet with a wetting fluid in a manner to produce a wetted de-aired granular carbon material. Suitable wetting fluids include formaldehyde solutions, water, lower molecular weight alcohols, and any liquid that will not interrupt or change polymerization process. Suitable alcohols include methanol, ethanol, n-propanol, I-propanol, n-butanol, I-butanol, and mixtures of these. The alcohol or alcohol mixture can also include water. Alcohols are desirable wetting agents because they are inert, volatile, and have a low surface tension, which facilitates penetration of pores in the granular material.

De-Airing of the Wetted Granular Conductive Material

One of the reasons to first Wet the granular carbon material is to saturate the material and drive off all of the air, which is trapped within the porous material. This process can therefore be called a de-airing process. Since the granular carbon material has a high surface area, the wetting of the material with a wetting fluid gets the wetting fluid into all the pores inside the granular carbon material before the polymer solidifies. This is desirable and important so that bonding results to these reinforcing particles (the granular carbon material) in order to achieve the physical and electrical characteristics that are needed for the electrode.

Thus, the de-airing and the wetting of the granular carbon material with the wetting fluid are important steps to insure that the end result be a usable robust electrode. During this process, the granular conductive carbon material is slowly introduced to a polymer liquor and wetting fluid mixture with molar ratios of about 0.4-0.6 to 1.0 crosslinker to polymerization monomer with a wetting fluid which is about 20% to 30% of volume of the granular conductive material by means of mixing at temperatures under 100° F. During this time visible air bubbles are coming out of the mixture. Preferably, this procedure is undertaken in a sealed tank environment that is or can be connected to a vacuum and includes some type of stirring mechanism in the tank to ensure that the mixture is stirred. Such a vessel can be referred to as a de-airing vacuum tank or a de-airing stirring tank.

In one embodiment, the tank is constructed from 304 stainless steel materials and has an appropriately designed stirring wheel inside for constantly and controllably stirring the wetted material. When the tank is operatively connected to a vacuum to accomplish the de-airing of the material, the tank is first filled with the dry granular carbon material and a vacuum is created. The strength of the vacuum depends upon different parameters ant the given application; however, suitable vacuum strengths are on the order of between about two to four atmospheres. However, these are merely exemplary strengths and the actual strength of such a vacuum is not critical to the practice of the present invention. After the vacuum is formed, the liquid polymer with wetting fluid is introduced under vacuum and the gas form within the tank is vented as the liquid displaces the gas inside the tank. The gas is thus vented as it is displaced out of the tank and the liquid is allowed to fill the spaces inside the vacuum reduced granular carbon material. The vacuum is not reduced or relieved until the granular material inside the tank has been covered with the liquid.

It will be appreciated that any of the aforementioned polymer liquors can be used in the de-airing process.

The de-airing of the material also results in the formation of a better electrode in that the de-airing process affects density of the electrode as well as other physical properties.

After the wetted granular carbon material is de-aired, the next steps in the process of forming the electrode are to add the final amount of crosslinker and to polymerize the material at a proper predetermined temperature.

Polymerization of the Wetted Granular Carbon Material

Any irregularity of the manufacture of the electrode can result in a failure that would make the material unusable. The present applicants have observed that temperature control in the polymerization step is more important in the production of the electrode from the granular carbon material compared to the actual formation of the granular carbon material. There are at least several important issues in the polymerization. One issue is that the granular carbon material will settle if it is not stirred during the polymerization process and as a result, stirring of the granular carbon material is needed in order to keep the material in suspension. The stirring can be accomplished using any number of different types of devices as previously disclosed. Static in-line mixer, similar to an extrusion tip, can be used and this would involve controlling the polymerization to the point where the mixture is, thick enough so that the particles do not settle once they have been extruded into the mold. In addition, the material should be polymerized at a temperature and rate that does not result in boiling or lumps and the stirring of the material should continue until the material can be dispensed into the mold without settling.

An alternative to forming the polymer liquor from the polymerization monomer, crosslinker, etc., is to use a commercially available mix that reduces some of the preparation time. However, even when a commercially available mix is used, it is important to combine the appropriate molar ratios, no matter what the source of formalin and resorcinol with the de-aired granular carbon material. The polymer liquor and the granular carbon material is mixed under a selected, controlled temperature that is preferably below 125° F., with the surface area thereof being exposed to the mass heat exchanger. The amount of stirring that is required depends upon a number of factors, including whether a catalyst, such as a base catalyst, is being used. As previously mentioned, some suitable catalysts include but are not limited to sodium carbonate 1M; sodium hydroxide; potassium hydroxide; calcium carbonate; calcium bicarbonate, etc. The goal of the mixing operation is to produce a material that is as homogenous as possible as it thickens to its hardened state and one in which the granular carbon material is preferably substantially evenly distributed, both vertically and horizontally.

It will also be appreciated that the polymerization process can be conducted under pressure since this permits several process related parameters to be controlled. For example, if the mold is placed in a pressure vessel and then is reacted to polymerize the material contained therein, the pressure can be increased; the time needed for polymerization of the product can be shortened; and the polymerization temperature can be controlled. This is also true when the polymer liquor is polymerized to form the blank that is used to form the granular conductive carbon material.

After the stirring of the mixture is stopped and the mixture has obtained the proper consistency, the material is placed into the mold. In one embodiment, the mold containing the polymer liquor mixture is introduced to convection type heating between about 70° F. to 145° F. for a time period of about 24 to 72 hours. Other heating sources may be used to maintain the desired temperature. During this curing stage, the in-mold cured blocks are hard and damp with some unreacted formaldehyde and are electrically non-conductive. One purpose of this in-mold heating is to complete the polymerization and allow hardening and shrinkage so that the block can be remove form the mold.

Carbonization of the Electrode Material

After the electrode has cured for a sufficient period of time, it is then removed from the airtight curing environment and is then placed into a firing environment where it will undergo carbonization. This environment is typically in the form of an oven (furnace) or the like and preferably, the oven is constructed in the same manner described hereinbefore with reference to the polymerization of the blank material. In other words, the oven is configured and includes a fixed refractory and a movable refractory. The electrode itself, without a mold pan, is inserted into the oven and the movable refractory is lowered into place over the electrode and then the door of the oven is closed.

During the firing process, it is important that the electrode achieves a temperature of between about 900-975° C. from edge to edge. In other words, the polymer electrode is heated such that the electrode material is heated to this temperature completely through the electrode in a homogenous manner.

After the electrode is held at this temperature for a predetermined period of time, the electrode is then removed from the oven and it will likely begin to flame when it comes into contact in an oxygen environment. The electrode is placed into a snuffbox or the like where, once again, a reduced oxygen environment is maintained until the electrode cools to about 200° C. As soon as the electrode reaches this cooled temperature, the electrode is removed form the snuffbox and is allowed to cool to room temperature.

Particle Size of the Granular Material used to make the Electrode

With respect to the particle size and the distribution of the particle size, the variability of these parameters can be used to influence at least four characteristics of the electrode. More specifically, the four characteristics are (1) resistivity; (2) friability which is a measure of whether the material falls apart as it is touched, rubbed grinded, or otherwise handled; (3) physical strength of the material—the material needs to have sufficient physical strength in order for the material to be sawed, sanded, carried, grooved, soldered, etc.; and (4) the ability of the electrode to absorb water well. It has been observed that when the electrode is formed with big particles (200 microns or larger), the resulting electrode has very good flow characteristics but has very poor physical strength and poor friability and resistivity. Conversely, when the ground carbon material is in the form of a dust, having a size that is below a tenth of a micron, the strength of the electrode goes up. Increasing the concentration of small particles also causes the electrode to have increased hardness and less flow through porosity. Accordingly, by controlling particle size and particle distribution, one can control, with a select range, the physical, hydraulic and possibly electrical characteristics of the electrode. In one embodiment, the granular material is formed of particles where at least 75% of the particles have a particle size between about 20 microns and 100 microns.

Machining/Finishing of the Electrode

Once the electrode cools to room temperature, the electrode has its full strength and at this point, the electrode can be handled from the oven and delivered to a further processing or electrode finishing area, which can be in the form of a sawing, sanding and trimming area.

In other words, after the electrode is cooled to room temperature and is at full strength, the electrode is machined or otherwise finished to produce a finished electrode. One exemplary first finishing step is to trim the edges of the electrode. There are two operations that have to be performed on the electrode. The first is that the electrode has to be trimmed and squared and then sanded to a predetermined desired thickness. The electrode is thus flat and true completely across all surfaces and thus, this operation can be referred to as squaring the electrode. One exemplary electrode is in the form of a 24 inch square that has a thickness of from about 3/16 inch to about ⅜ inch. The second step is attaching an electrical connection to the electrode that will allow the electrode to be introduced to a power source. Material selection is critical considering the electrical connection may be submersed in a water/electric field type environment.

Regardless of the exact specifics of the electrode plate, when it is used in a deionization apparatus, it must be supplied with a voltage. This can be done with a rod or wire, such as formed from copper or other conductor. However, if the rod or wire is exposed to the liquid being deionized, the rod or wire will be damaged (by being sacrificed). Therefore, a dry connection between the rod or wire and the plate is preferably established.

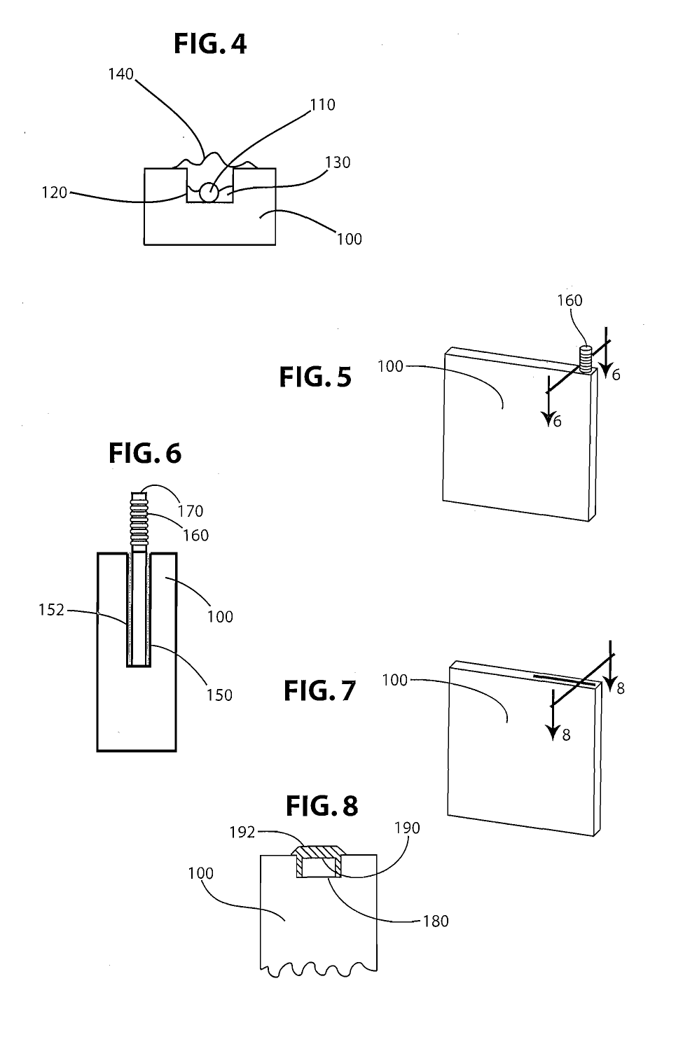

FIGS. 3-4 illustrate how such a dry connection can be made between the electrode (electrode plate) 100 and a conductor 110, preferably an insulated copper wire between 8-18 AWG, also other thicknesses can be used. The connection between the conductor 110 and the electrode plate 100 is formed by drilling a channel or groove 120 into the plate across one edge thereof. The stripped conductor 110 is laid into the groove 120 such that the free end of the wire extends outwardly away from the electrode plate 100 for electrical connection to the power source. The stripped conductor 110 is then securely attached or connected to the electrode plate 100 by any number of conventional means, including the use of a solder material 130. In order to prevent water from reaching and breaking down the electrical connection, a protective coating 140 is disposed across the electrode plate 110 to effectively encase the electrical connection. For example, the electrode plate 110 can be saturated with a marine grade nonconductive epoxy, such as 2-part epoxy resin #2, from Fibre Glass Evercoat, of Cincinnati, Ohio. The nonconductive epoxy 140 seals the region around the copper wire 110, while not disturbing the preexisting electrical connection between the exposed wire 110 and the plate (electrode) 100. It will be appreciated that the protective coating is not limited to the above-mentioned material but rather can be any number of different materials so long as the material can soak into the carbon electrode plate 100 and not be sacrificial during the operation of the electrode plate 100. In addition, once the protective coating is applied to the carbon, the protective coating can not change its shape since this could lead to and cause a change of shape of the electrode plate 100, thereby diminishing the integrity of the electrode plate 100.

In another embodiment shown in FIGS. 5-6, the electrical connection to the electrode plate 100 is formed by drilling a bore 150 directly into the electrode plate 100 along one edge thereof and preferably close to one of the corners of the electrode plate 100. In the illustrated embodiment, the bore 150 is drilled into the upper edge of the electrode plate 100 and then a solder material 152 is disposed within the bore 150 so as to essentially fill the bore 150. A conductor 160 is then inserted into the filled bore 150 and is frictionally or mechanically maintained therein, with the solder material being disposed between the conductor 160 and the electrode plate 100. There is no bond between the solder material and the carbon of the electrode plate 100 but rather, there is merely a mechanical fit therebetween. The conductor 160 can be in the form of a threaded bolt or the like that is frictionally fit into the filled bore 150 such that it is securely held therein and one end (free end) 170 of the conductor 160 protrudes and extends outwardly from the edge of the electrode plate 100. This end of the conductor 160 is free for connection to the power source as by an electrical cable or the like that is attached to the free end of the conductor 160. Alternatively, the free end of the conductor 160 can be threaded such that it is threadingly mated with a complementary threaded conductor, such as a threaded connector or bolt member so as to permit this second conductor to be threadingly mated to the conductor 160 to establish an electrical connection to the power source.

It should be noted here that the sealed electrical connection can also be made by first saturating the plate with the nonconductive epoxy, drilling the hole, and inserting the stripped copper wire and then applying additional epoxy to form the seal. Other variations can include forming a channel, rather than simply a hole, in the edge of the plate, and then inserting a wire strip of an electrical connector before sealing with the epoxy. The basic principal is to form an electrical connection in a region of the plate and then seal the area surrounding the connection with a material that preferably does not affect the electrical properties of the plate (electrode).

However, it is possible to use different types of plastic or epoxy as the protective coating over the conductive wire so long as the epoxy or protective coating is capable of soaking up in the electrode and encasing the connection and preventing water during operation from contacting the solder and the copper wire because they will sacrifice during operation. In other words, the substance has to wick into the electrode and encase it on the outside without affecting the electrical conductivity and without insulating the soldered connection. The advantages of this method are that it preserves the electrical connection and it makes it an easy electrical connection.

In another embodiment, the electrical connection to the electrode is formed using a flame spraying contact deposition technique that is generally illustrated in FIGS. 7-8. In this embodiment, a channel or groove 180 is formed (e.g., as by machining) along one edge of the electrode plate 100 and then a conductive material 190 is flame sprayed onto and along the one edge of the electrode plate 100 so as to form and define a conductive pathway or electrical contact for the electrode plate 100. By flame spraying the conductive material, the contact can be easily formed along the electrode 180 and can easily be formed to have any number of shapes. For example, the channel 180 that receives the conductive material does not have to be simply linear in nature but rather it can include one or more bends or curves formed therein for any number of reasons, including mounting and application considerations.

After disposing the conductive material 190 into the channel 180 to form the conductive pathway, the structure is sealed using the techniques described above. For example, the conductive material 190 can be coated with a sealing material 192, such as one of the above thermoplastic materials so as to preserve the integrity of the electrical connection formed between the conductive material 190 and the carbon of the electrode plate 100.

The present applicants have discovered that the use of granular carbon material (either by creating this material from scratch or by starting with pre-prepared material), the resulting electrode 100 has increased electrical conductivity and the granular carbon material reinforces the electrode. The specifications of the electrode 100 will vary depending upon the application; however, exemplary electrodes 100 have a density of about 0.5 g/cm3 to about 2.5 g/cm3.

The physical dimensions of the electrode 100 will vary from application to application; however, according to one exemplary embodiment, the electrode 100 has a thickness of from about 3/16 inch to about ⅜ inch; a height from about 10 inches to about 24 inches and a width from about 10 inches to about 24 inches. While the exemplary electrode described above has been described and illustrated as having a square shape, it will be understood that the electrode can have a number of other shapes. For example, the electrode can have a rectangular shape or triangular shape or any other type of shape, including regular and irregular shapes, to take advantage of flow and mechanical characteristics of those shapes. In other words and according to one particular application, the electrodes are arranged in the deionization apparatus such that the electrodes provide parallel absorptive surfaces defined by a geometric shape having a thickness between them. For example, the geometric shape can be either a regular shape or an irregular shape and more particularly, the geometric shape can be in the form of a square, rectangle, trapezoid, circle, ellipse, cylinder, etc.

### EXAMPLE

An electrode was manufactured according to the principles set forth above and the following properties/characteristics were measured and are set forth in the following Tables:

AREA

| Property | Measured Value | |
|---|---|---|
| BET surface area | 481.41 | sq. m/g |
| Langmuir surface area | 541.89 | sq. m/g |
| Single point surface area at P/Po 0.1027 | 478.483 | sq. m/g |
| BJH cumulative adsorption surface area of | 21.6927 | sq. m/g |
| pores between 17.0000 and 3000.0000 A | | |
| diameter | | |
| Micropore area | 419.5970 | sq. m/g |

VOLUME

| Property | Measured Value |
|---|---|
| Single point total pore volume of pores less | 0.198113 |
| than 812.7211 A diameter at P/Po 0.9756 | |
| BJH cumulative adsorption pore volume of | 0.032289 cc/g |
| pores between 17.0000 and 3000.0000 A | |
| diameter | |
| Micropore volume | 0.166676 cc/g |

PORE SIZE

| Property | Measured Value |
|---|---|
| Average pore diameter (4 V/A) by | 14.6238 A |
| Langmuir | |
| BJH adsorption average pore diameter | 59.5384 A |
| (4 V/A) | |

It will be appreciated that the above Example is merely exemplary and illustrative and is not limiting of the present invention. In other words, the above properties and measured values are merely illustrative of data obtained for a particular electrode of the present invention and therefore, electrodes made in accordance with the present invention can be outside of the above measured values.

In addition, the electrodes made in accordance with the present invention underwent further quantitative analysis and the results were compared to results obtained from conventional electrodes under the same test conditions. More specifically, the present electrode materials were subjected to X-ray diffraction (XRD) analysis. As is well know, XRD analysis characterizes the crystalline, or amorphous, nature of a typically although not necessarily a solid material. During the experiment, the samples of the present electrodes produced by the methods described above and having the characteristics described above, including those listed in the above Example, were pulverized and placed in a suitable sample holder and then exposed to an incident beam of x-rays. The same was done for other commercially available carbonaceous materials in order to compare the XRD analysis (material fingerprint so to speak) of the present materials and conventional electrode materials, and in particular, aerogel based electrodes (e.g., MarkeTech Aerogels).

The particles were less than 200 mesh (74 microns) in size. In addition, previous analysis and testing indicated that the particles were approximately uniform and therefore, they were not rod or plate-like.

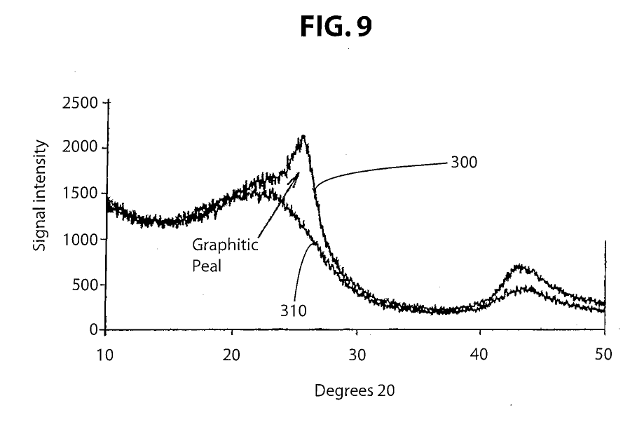

The pulverized power samples were exposed to Copper K alpha wavelength radiation and were scanned by the incident beam over an angular range of 20 to 30 degrees with diffracted intensity measured in steps of 0.2 degrees. Crystalline structure within the sample is shown and indicated by peaks in the diffracted intensity plots, which are unique to crystalline chemical structures or morphologies. In carbonaceous materials, graphite has a unique crystal structure and thus, an identifiable XRD set of peaks. FIG. 9 is a graph showing an exemplary sample XRD analysis of both an electrode made in accordance with the present invention, which is indicated by curve 300, and a conventional electrode made from an Aerogel material, generally indicated by curve 310. The results in FIG. 9 illustrate curves that reflect a compilation of data and a number of resulting curves such that curve 300 is illustrative of a curve that has been calculated when XRD analysis is performed on the electrode materials of the present and similarly, the curve 310 is illustrative of a curve that has been calculated when XRD analysis is performed on conventional electrode materials and in particular on electrodes made from Aerogel materials.

In the electrode materials of the present invention, one of the graphitic peaks was present at approximately 25 degrees on the horizontal axis. This peak is superimposed on a very broad, essentially amorphous, peak extending from 15 to 35 degrees. This graphitic peak at this location has been detected in all of the electrode samples made in accordance with the method of the present invention, with the peak height (diffracted intensity) varying slightly from one electrode material to another due to varying process conditions, such as different heating profiles, e.g., different heating time periods and/or temperatures. As can be seen in FIG. 9, the curve 310 that reflects the conventional Aerogel based electrodes does not have such a graphitic peak in the area of approximately 25 degrees on the horizontal axis. Similarly, this graphitic peak was likewise absent in three “activated carbon” commercial materials subjected to the same XRD analysis. Thus, the conventional electrode materials appear to be lacking the particular graphitic structure of the electrodes of the present invention since the XRD analysis of these materials regularly shows an absence of a graphitic peak in the area of 25 degrees on the horizontal axis. Applicants believe that the present of this graphitic peak in the XRD analysis of the present electrodes indicates that the present electrodes have a different crystal structure compared to the conventional electrodes which used carbon filler materials and that this different crystalline structure results in the electrodes of the present invention having improved ion capacity as well as the other improved properties and characteristics described hereinbefore.

What is claimed is:

1. A process for forming an electrode comprising the steps of:
wetting a granular conductive carbon material with a wetting fluid, solvent, and first crosslinker to form a first mixture;
mixing the first mixture with a second crosslinker;
maintaining the first mixture for a sufficient time and at a sufficient temperature until the first mixture polymerizes into a block; and
firing the block for a sufficient time and at a sufficient temperature such that the block carbonizes into an electrically conductive substrate.

2. The process of claim 1, wherein the polymerization monomer is selected from the group consisting of dihydroxy benzenes, dihydroxy napthalenes, trihydroxy benzenes and trihydroxy napthalenes and mixtures thereof.

3. The process of claim 1, wherein the first crosslinker and the second crosslinker are formaldehyde.

4. The process of claim 1, wherein the granular conductive carbon material is formed by:
dissolving at least one material selected from the group consisting of dihydroxy benzenes, dihydroxy napthalenes, trihydroxy benzenes and trihydroxy napthalenes and mixtures thereof, in the first crosslinker to form a partially reacted mixture;
mixing the partially reacted mixture with the second crosslinker to form a second mixture;
maintaining the second mixture for a sufficient time and at a sufficient temperature until the second mixture polymerizes into a blank;
firing the blank at a sufficient temperature and for a sufficient time such that the blank carbonizes into an electrically conductive member; and
processing the blank, after the blank cools, so as to break up the carbonized blank into the granular conductive carbon material.

5. The process of claim 4, wherein the first and second crosslinkers are formaldehyde and the first and second mixtures are the same.

6. The process of claim 4, wherein the first and second mixtures comprise a mixture of formaldehyde and resorcinol.

7. The process of claim 1, wherein at least 75% of the granular conductive carbon material comprises particles having a particle size between about 20 microns and about 100 microns.

8. A process for forming an electrode comprising the steps of:
dissolving at least one polymerization monomer in a first crosslinker to form a first liquor;
maintaining the first liquor for a sufficient time and at a sufficient temperature until the first liquor forms a partially reacted liquor;
mixing the partially reacted liquor with a second crosslinker to form a mixed first liquor and maintaining the mixed first liquor for a sufficient time and at a sufficient temperature until the mixed first liquor polymerizes into a first solid blank;
firing the first solid blank at a sufficient temperature and for a sufficient time such that the first solid blank carbonizes into an electrically conductive member;
processing the first solid blank, after the first block cools, so as to break up the carbonized blank into a granular carbon material;
wetting the granular carbon material with a wetting fluid that is a mixture of the first liquor and a wetting solvent;
mixing the wetted granular carbon material for a time and at a sufficient temperature to sufficiently de-air the granular carbon material;
adding a second crosslinker to the granular carbon material, solvent and first liquor mixture to form a second mixture;
maintaining the second mixture at a sufficient temperature and for a sufficient time until the second mixture polymerizes into a second solid blank; and
firing the second solid blank for a sufficient time and at a sufficient temperature such that the second solid blank carbonizes into an electrically conductive substrate.

9. The process of claim 8, wherein the temperature of the first liquor is maintained at between 120° F. and 145° F. during polymerization.

10. The process of claim 8, wherein the first solid blank is fired at a temperature of at least 900° C.

11. The process of claim 8, wherein the at least one monomer is resorcinol and one or more of the first and second crosslinkers comprise formaldehyde.

12. The process of claim 8, wherein the first solid blank is cured for more than 18 hours between 70° F. to about 125° F.

13. The process of claim 8, wherein the step of firing the first solid blank includes the step of:
providing an oven including a first refractory and a second refractory, wherein the first refractory is an upper refractory that is movable relative to the second refractory which is a stationary lower refractory, the upper refractory functioning as a holding weight and minimizing the oxygen atmosphere environment with the first solid blank being placed between the upper and lower refractories for the step of firing the first solid blank.

14. The process of claim 8, wherein during the step of firing the first solid blank, the first solid blank is heated so that the material thereof is uniformly raised to a temperature of at least about 975° C.

15. The process of claim 8, wherein the step of firing the first solid blank includes the step of:
purging the oven of atmosphere during an initial time period of the firing of the first solid blank through the creation of combustion gases that are formed as a result of carbonizing the first solid blank during the firing thereof.

16. The process of claim 8, wherein the step of processing the first solid blank comprises the steps of:
introducing chunks of the first solid blank though a crusher to form smaller pieces; and
introducing the smaller pieces into a jet mill that causes the smaller pieces to be broken down into the granular carbon material.

17. The process of claim 8, wherein at least 75% of the granular conductive carbon material comprises particles having a particle size between about 20 microns and 100 microns.

18. The process of the claim 8, wherein the step of wetting the granular conductive carbon material comprises the step of:
introducing the granular conductive carbon material to a partially reacted polymer liquor with solvent added and maintaining the wetted granular conductive carbon material in a de-airing environment between about 18 hours and 36 hours to permit the mixture to de-air.

19. The process of claim 8, wherein the step of mixing the granular carbon material with an additional amount of the second crosslinker to form the second mixture comprises the step of:
stirring the first mixture so as to keep the granular carbon material in suspension as the second mixture is polymerized into the second solid blank.

20. The process of claim 8, wherein after the step of polymerizing the second blank and before the step of firing the second blank, further including the step of:
placing the second blank in a air-tight sealed environment for at least 24 hours and up to 48 hours at a temperature between about 70° F. and about 145° F. to permit curing thereof.

21. The process of claim 8, further including the steps of:
placing the electrically conductive plate in a snuff apparatus after the firing step is completed;
cooling the electrically conductive plate to about room temperature; and
processing the electrically conductive plate by machining the plate to a preselected dimensions.

22. The process of claim 21, wherein the step of processing the electrically conductive substrate includes the steps of trimming and squaring the plate so that it is flat and true across all surfaces.

23. The process of claim 21, wherein the step of processing the electrically conductive substrate includes the step of:
applying an electrical connector.

24. The process of claim 23, further including the steps of:
securely coupling the electrical connector in place in a recess formed in the plate; and
sealing the electrical connector component within the recess.

25. The process of claim 8, wherein the first liquor and the wetting fluid are the same and are formed of mixture of formaldehyde and resorcinol.

26. The process of claim 8, wherein firing the first and second solid blanks includes the steps of:
providing an oven formed of a first refractory and a second refractory, the first refractor being a hearth refractory and the second refractory being a movable refractory;
disposing one of the first and second blanks between the first and second refractories; and
operating the oven so that the refractories provide a predetermined degree minutes per gram of heating so that the respective blank is raised to a predetermined temperature.

27. A process for forming an electrode comprising the steps of:
wetting a granular conductive carbon material with a first wetting fluid, solvent and first crosslinker and mixing the wetted granular conductive carbon material with an amount of a second crosslinker to form a first mixture;
maintaining the first mixture for a sufficient time and at a sufficient temperature until the first mixture polymerizes into a block;
firing the block for a sufficient time and at a sufficient temperature such that the block carbonizes into an electrically conductive substrate;
securely coupling an electrical connector component in place along a length of the block; and
sealing the electrical connector component.

28. The process of claim 27, wherein the polymerization monomer is selected from the group consisting of dihydroxy benzenes, dihydroxy napthalenes, trihydroxy benzenes and trihydroxy napthalenes and mixtures thereof.

29. An electrode for use in a deionization apparatus comprising:
a polymerization monomer;
a crosslinker; and
a catalyst; and
or reaction products thereof, together in a carbonized form that is free of a carbon fiber reinforcing agent that is added to a mixture of the polymerization monomer and the crosslinker.

30. The electrode of claim 29, wherein the polymerization monomer comprises at least one material from the group consisting of dihydroxy benzenes; trihydroxy benzenes; dihydroxy naphthalenes and trihydroxy naphthalenes and mixtures thereof.

31. An electrode for use in a deionization apparatus comprising:
a polymerization monomer;
a crosslinker; and
a catalyst;
or reaction products thereof, together in a carbonized form that is formed from a homogenous reinforcement material formed of a granular conductive carbon material that has substantially the same chemical composition as the electrode.

32. A process for forming an electrode comprising the steps of:
wetting a granular conductive carbon material with a wetting fluid, solvent, and first crosslinker to form a first mixture;
mixing the first mixture with a second crosslinker;
maintaining the first mixture for a sufficient time and at a sufficient temperature until the first mixture polymerizes into a block; and
firing the block for a sufficient time and at a sufficient temperature such that the block carbonizes into an electrically conductive substrate by subjecting the block to infrared energy emitted by an infrared oven.
